(19) United States
(12) Patent Application Publication
(10) Pub. No.: US 2009/0059357 A1
(43) Pub. Date: Mar. 5, 2009

(54) OPTICAL ARRANGEMENT AND A MICROSCOPE

(75) Inventors: Rafael STORZ, Pfaeffikon (CH); Volker Seyfried, Nussloch (DE)

Correspondence Address: FOLEY AND LARDNER LLP;SUITE 500, 3000 K STREET NW, WASHINGTON, DC, 20007, US

(73) Assignee: LEICA MICROSYSTEMS CMS GmbH

(21) Appl. No.: 12/195,871

(22) Filed: Aug. 21, 2008

(30) Foreign Application Priority Data
Aug. 23, 2007 (DE) 10 2007 039 988.1

(51) Int. Cl. G02B 21/36; G02B 21/00

(52) U.S. Cl. 359/363; 359/368; 359/380

(57) ABSTRACT

An optical arrangement having an optical assembly (1) for generating an intermediate image (2) in a beam path is configured and further developed such that an optical element (3) having a plurality of optical waveguides (4) is arranged in the beam bath after the intermediate image (2) to enable the imaging of the intermediate image (2) in a plane on a zone-by-zone or point-by-point basis. Further, a microscope exhibiting such an optical arrangement is specified.

### CROSS-REFERENCE TO RELATED PATENT APPLICATIONS

The right of foreign priority is claimed under 35 U.S.C. § 119(a) based on Federal Republic of Germany Application No. 10 2007 039 988.1, filed Aug. 23, 2007, the entire contents of which, including the specification, drawings, claims and abstract, are incorporated herein by reference.

### BACKGROUND OF THE INVENTION

The present invention relates to an optical arrangement with an optical assembly for the generation of an intermediate image in a beam path. The present invention further relates to a microscope containing said optical arrangement.

Optical arrangements and microscopes of the aforementioned type are known in the field and exist in the most varying embodiments. Depending on the optical assembly used, the known optical arrangements are very prone to field curvatures in the intermediate image. Such field curvatures occur, for example, when employing chromatically optimized lens systems (TOH). Indeed this means that a very high Z-resolution can be achieved in the image, for example in the chromatic case of 405 mn up to 700 nm and more. However, this is only possible by neutralizing the condition that the Petzval sum is equal to zero, which in turn means that there is a tolerance in the flatness of the image. If such optical arrangements are used in connection with plane detectors such as CCD chips then the image will always appear to be curved in the space.

It is known in the state of the art to use lens systems in order to compensate such field curvatures. However, said lens systems are complex in their structure and complicated to operate.

### SUMMARY OF THE INVENTION

Accordingly, the task of the present invention is to provide an optical arrangement and a microscope of the aforementioned type, which enables the compensation or reduction of a curvature of field in an intermediate image with simple structural means.

According to the invention said task is solved by an optical arrangement having the features specified herein. In view of that, the optical arrangement is so configured and further developed that an optical element having a plurality of optical waveguides is arranged in the beam path after the intermediate image for the imaging of the intermediate image in a plane on a zone-by-zone or point-by-point basis.

It was recognized in accordance with the invention that through a smart selection of a suitable optical element said task can be solved in a surprisingly simple manner. For this, according to the invention, the optical element is further provided with a plurality of optical waveguides for imaging the intermediate image in a plane on a zone-by-zone or point-by-point basis. The intermediate image is quasi screened into individual points or zones by the optical waveguides. The information picked up by the individual optical waveguides from the assigned zones or points of a curved intermediate image is imaged in one plane via the optical waveguides so that an existing curvature of the intermediate image is transferred or reduced to a plane. Hence, the image in a CCD detector, for example, no longer appears curved in space.

Consequently, the optical arrangement according to the present invention provides an optical arrangement which enables the compensation or reduction of a field curvature with simple structural means.

In a specific embodiment of the optical element, the optical waveguides may be arranged next to each other and/or in parallel. Thus, a particularly compact embodiment of the optical element can be achieved. The optical element may be formed as an optical waveguide plate.

In order to provide a particularly high-resolution optical element, the optical waveguides may be formed as capillaries, preferably micro-capillaries. Said capillaries may, for example, have a diameter of 5 μm. Consequently, a particularly fine “screening” of the intermediate image could be achieved.

In an alternative embodiment, the optical waveguides may be formed as optical fibers or contain optical fibers. Accordingly, an optical waveguide may be made up of a plurality of optical fibers.

Said optical waveguides could enable a point-to-point imaging from one end of the optical element to the other end of the optical element.

With regard to a particularly reliable imaging of a curved intermediate image in a plane, the optical element could be adapted at its input end to the curvature of the intermediate image or the field curvature of the optical assembly. In other words, the optical element may be of a curved form at its input end.

Further, with regard to a particularly reliable imaging of the intermediate image in a plane, the output end of the optical element may be of a planar form. In each case, the optical element is to be formed such that the field curvature or a curvature of the intermediate image can be compensated or reduced by this element.

In concrete terms, preferably a plane detector may be arranged at the output end of the optical element. Said detector may be used for analyzing the intermediate image imaged via the optical element.

In accordance with the imaging of the intermediate image in the plane on a zone-by-zone or point-by-point basis, the detector may dispose a CCD array, a CMOS or an APD chip. Said detector further enables a detection and analysis of the image on a zone-by-zone or point-by-point basis.

With regard to a particularly high-quality and reliable analysis and detection, the arrangement of optical waveguides may be adapted to the arrangement of sensitive areas of the detector or to the detector mask. In concrete terms, the adaptation with regard to the array screen and/or the size of the sensitive areas and/or the shape of the sensitive areas and/or the orientation of the sensitive areas can be realized. In view of this, the light from a single optical waveguide may be directed to exactly one sensitive area or screen dot. In other words, the arrangement of optical waveguides may be adapted to the individual detector pixels.

With regard to a particularly reliable imaging and detection of the intermediate image, the optical element or the optical waveguides may be micro-optically connected to the detector. The optical element and the detector may be formed as an integral or coupled assembly.

To enable an adaptation to different field curvatures, the optical element or the optical waveguides may be replaceable. In view of this, the use of differently formed optical waveguides, such as capillaries and optical fibers could be realized in an optical element.

In a further advantageous embodiment, an adaptation of the field flow—diameter—may be achieved by adapting the optical element. The optical element may dispose a zoom-in function for this purpose.

In a concrete embodiment of the optical arrangement, the optical assembly may be a chromatically-optimized lens system—a TOH optical system. However, other lens systems can also be used as an optical assembly.

The aforementioned task is further solved by a microscope with said optical arrangement. In order to avoid repetitions, reference is made to the above description of advantages and embodiments of the optical arrangement claimed.

Using the optical arrangement according to the invention and the microscope according to the invention it is possible to reduce the curvature of an intermediate image or the field curvature of an optical system to a plane. To achieve this, a specially structured optical medium—the optical element - is used. For example, the optical element may exhibit micro-capillary structures. They may be made up of capillaries arranged next to each other, acting pointwise as optical waveguides and enable a point-to-point imaging from one end of the optical element to the other end. By arranging the optical element in an imaging beam bath it is possible to compensate field errors. The optical waveguides can be arranged array-like so that the transmitted light only emerges at certain points arranged in an array-like manner. The points may be arranged such that they just concur with the sensitive areas of a detector array.

There are various possibilities for configuring and further developing the teaching of the present invention in an advantageous fashion.

Further objects, features and advantages of the present invention will become apparent from the detailed description of preferred embodiments that follows, when considered together with the accompanying figures of drawing.

### BRIEF DESCRIPTION OF THE DRAWINGS

FIG. 1 is a schematic illustration of an embodiment of an optical arrangement in accordance with the invention,

FIG. 2 is a rectangular section of the optical element of FIG. 1, in a schematic, enlarged and top plan view of the output end and

FIG. 3 is a schematic and perspective side view of a fiber-optical element made of optical fibers.

### DETAILED DESCRIPTION OF THE PREFERRED EMBODIMENTS

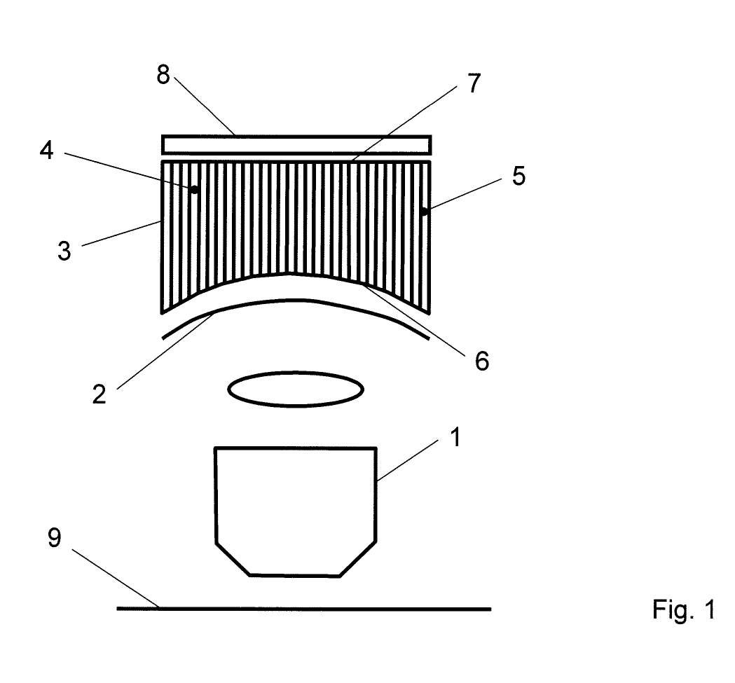

FIG. 1 shows an embodiment of an optical arrangement according to the invention having an optical component 1 for generating an intermediate image 2 in a beam path. With regard to a compensation or reduction of a field curvature with the aid of simple structural means, an optical element 3 having a plurality of optical waveguides 4 is arranged in the beam path after the intermediate image 2 to enable the imaging of the intermediate image 2 in a plane on a zone-by-zone or point-by-point basis.

The optical waveguides 4 are arranged in parallel and next to each other and are formed as capillaries 5 or preferably as micro-capillaries. As a result, the intermediate image 2 is imaged in a plane on a quasi point-by-point or zone-by-zone basis. A curvature of the intermediate image 2 is thereby compensated.

The input end 6 of the optical element 3 is adapted to the curvature of the intermediate image 2. The output end 7 of the optical element 3 has a planar form.

At the output end 7 of the optical element 3 a plane detector 8 is arranged in the form of a CCD chip. The arrangement of the optical waveguides 4 is adapted to the chip or array screen of the CCD. In other words, one capillary 5 is assigned to each sensitive area of the detector 8 so that the light of the intermediate image 2 directed by the one capillary 5 is imaged to exactly one sensitive area.

The optical element 3 forms an integral part of the detector 8, wherein a separate arrangement in the form of two assemblies is also possible. The optical assembly 1 is a TOH optical system, which can be used to investigate a specimen 9.

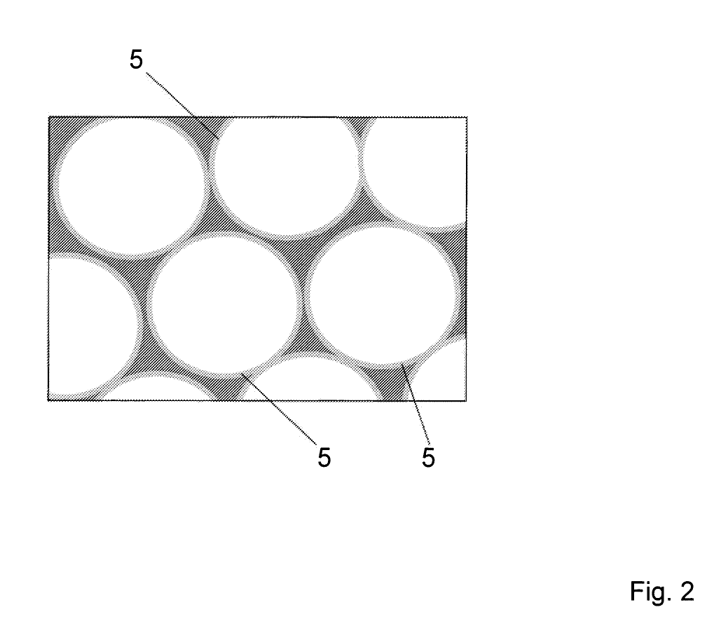

FIG. 2 shows a rectangular section and in a schematically enlarged top plan view of the output end of the optical element 3 of FIG. 1. The micro-capillary structure of the capillaries 5 is clearly visible. The arrangement of the capillaries 5 is adapted to the screen of the CCD chip.

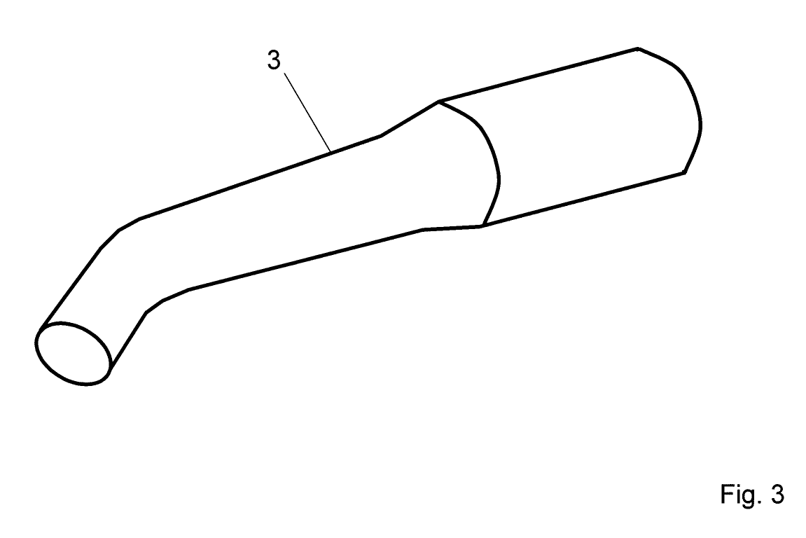

FIG. 3 shows a schematic and perspective side view of a fiber-optical element 3 made of optical fibers. Providing a suitable configuration said element may also be used as an optical element for imaging an intermediate image 2 in a plane on a zone-by-zone or point-by-point basis. Such an optical element could exhibit a zoom-in function.

With regard to further advantageous embodiments and developments of the teaching according to the invention, reference is made on the one hand to the general part of the description and on the other hand to the appended claims.

Finally, it is understood that the foregoing, merely arbitrarily selected embodiments serve to explain only the teaching of the present invention, however, without limiting same to these embodiments.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined with reference to the claims appended hereto and that the claims encompass all embodiments of the invention, including the disclosed embodiments and their equivalents.

### LIST OF REFERENCE NUMBERS

1 Optical assembly
2 Intermediate image
3 Optical element
4 Optical waveguides
5 Capillary
6 End
7 End
8 Detector
9 Specimen

What is claimed is:

1. An optical arrangement having an optical assembly for generating an intermediate image in a beam path, wherein an optical element having a plurality of optical waveguides is arranged in the beam path after the intermediate image to enable the imaging of the intermediate image in a plane on a zone-by-zone or point-by-point basis.

2. The optical arrangement according to claim 1, wherein the optical waveguides are arranged next to each other.

3. The optical arrangement according to claim 1, wherein the optical waveguides are arranged parallel to each other.

4. The optical arrangement according to claim 1, wherein the optical waveguides are formed as capillaries.

5. The optical arrangement according to claim 1, wherein the optical waveguides comprise optical fibers.

6. The optical arrangement according to claim 1, wherein the optical element is adapted to the curvature of the intermediate image or the field curvature of the optical assembly at its input end.

7. The optical arrangement according to claim 1, wherein the optical element is of planar form at its output end.

8. The optical arrangement according to claim 1, wherein a detector is arranged at the output end of the optical element.

9. The optical arrangement according to claim 8, wherein the detector comprises a CCD array, a CMOS or an APD chip.

10. The optical arrangement according to claim 1, wherein the arrangement of optical waveguides is adapted to the arrangement of sensitive areas of a detector or to a detector mask.

11. The optical arrangement according to claim 10, wherein adaptation with regard to an array screen and/or the size of the sensitive areas and/or the shape of the sensitive areas and/or the orientation of the areas is realized.

12. The optical arrangement according to claim 8, wherein the optical element or the optical waveguides is or are micro-optically contacted to the detector.

13. The optical arrangement according to claim 12, wherein the optical element or the optical waveguides is or are exchangeable.

14. The optical arrangement according to claim 1, wherein the optical element exhibits a zoom-in function.

15. The optical arrangement according to claim 1, wherein the optical arrangement comprises a chromatically optimized lens system—a TOH optical system.

16. A microscope having an optical arrangement according to claim 1.

17. The optical arrangement according to claim 1, wherein the optical waveguides are formed as micro-capillaries.

18. The optical arrangement according to claim 1, wherein a flat detector is arranged at the output end of the optical element.
